(19) United States
(12) Patent Application Publication
(10) Pub. No.: US 2015/0346813 A1
(43) Pub. Date: Dec. 3, 2015

(54) HANDS FREE IMAGE VIEWING ON HEAD MOUNTED DISPLAY

(71) Applicants: Aaron Michael Vargas, Pleasanton, CA (US); Oliver Aalami, Palo Alto, CA (US)

(72) Inventors: Aaron Michael Vargas, Pleasanton, CA (US); Oliver Aalami, Palo Alto, CA (US)

(21) Appl. No.: 14/729,803

(22) Filed: Jun. 3, 2015

Related U.S. Application Data
(60) Provisional application No. 62/007,008, filed on Jun. 3, 2014.

(51) Int. Cl. G06F 3/01; G06F 3/0484; G06F 3/0481

(52) U.S. Cl. CPC G06F 3/012; G06F 3/017; G06F 3/04812; G06F 3/04845

(57) ABSTRACT

Disclosed are a system and a method for hands free operating of a head mounted device. An example method includes reading sensor data from sensors associated with a head mounted device worn by a user. The method allows recognizing, based on the sensor data, a gesture generated by a movement of a head of the user. In response to the recognition, an operation associated with the recognized gesture and a mode of the head mounted device of the head mounted device is performed. The gesture can include a rotation, a pitch, and a roll. The operation includes zooming an image on a screen of the head mounted device, panning the image, scrolling a series of images on the screen, and switching modes of the device. A speed of execution of the operation is proportional to a ratio determined from an angle of the head movement.

### RELATED APPLICATIONS

The present application claims the benefit of U.S. Provisional Application No. 62/007,008, filed Jun. 3, 2014. The subject matter of the aforementioned application is incorporated herein by reference for all purposes.

### TECHNICAL FIELD

This disclosure relates generally to systems and methods for interacting with electronic devices and, more specifically, to systems and methods for hands free operating of a head mounted device.

### BACKGROUND

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

Viewing individual images and sets of images is required in a wide range of operations. In some situations, it is either necessary or helpful that the hands of a user viewing the images are free to perform other operations. For example in medical, mechanical, and other occupations, the user's hands may be occupied by tools and therefore not able to manipulate controls for viewing images. At the same time the user may need to manipulate images. For example, a physician may need to list, span, enlarge, and rotate certain images during a medical procedure.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

Presented are systems and methods for hands free operating of a head mounted device. An example method includes reading sensor data from at least one sensor associated with a head mounted device. The head mounted device can be worn by a user. The method can allow recognizing, based on the sensor data, a gesture generated by a movement of the head of the user. In response to the recognition, an operation of the head mounted device can be performed. The operation can be associated with the recognized gesture and a mode of the head mounted device.

In some embodiments, the gesture includes a rotation, a pitch, and a roll. The operation can include zooming in and zooming out an image displayed by a screen of the head mounted device. In certain embodiments, the operation includes panning the image on the screen. In some embodiments, the operation includes scrolling a series of images on the screen and switching the mode of operation.

In some embodiments, the switching of the mode is carried out in response to a left head tilt for at least a pre-determined angle.

In some embodiments, zooming out the image is carried out in response to rotating of the head from the center to the right. The zooming in the image can be carried out in response to rotating the head from the center to the left.

In some embodiments, a direction of scrolling the series of the images is determined in response to the rotation of the head from the center to the left or to the right.

In some embodiments, the recognition of the gesture includes determining a ratio based at least on the angle associated with of the movement and a pre-determined maximum angle in a direction of the movement. The speed of execution of the operation is proportional to the ratio. In certain embodiments, the method includes providing an indicator on the screen of the head mounted device. The indicator shows a degree of fulfillment of the operation.

In some embodiments, the recognition of the gesture includes determining that parameters of the movement exceed minimal pre-defined thresholds.

In various embodiments, the mode of the head mounted device includes at least “zoom”, “pan”, and “scroll”.

In further example embodiments of the present disclosure, the method steps are stored on a machine-readable medium comprising instructions, which when implemented by one or more processors perform the recited steps. In yet further example embodiments, hardware systems or devices can be adapted to perform the recited steps. Other features, examples, and embodiments are described below.

### BRIEF DESCRIPTION OF THE DRAWINGS

Embodiments are illustrated by way of example and not limitation in the figures of the accompanying drawings, in which like references indicate similar elements and in which:

FIG. 1 illustrates a block diagram showing an example environment 100, within which a method for hands free operating a head mounted device can be practiced.

FIG. 2 is a block diagram showing components of an example head mounted device suitable to practice methods of present disclosure.

FIG. 3 illustrates an example screen of a “zoom” mode for hands free viewing images on a head mounted device.

FIG. 4 illustrates an example screen of a “pan” mode for hands free viewing images on a head mounted device.

FIG. 5 illustrates an example screen of a “scroll” mode for hands free viewing images on a head mounted device.

FIG. 6 illustrates a dial indicator for switching modes, according to an example embodiment.

FIG. 7 is a block diagram showing a system 700 for hands free operating of a head mounted device, according to an example embodiment.

FIG. 8 is a block diagram showing example parameters associated with the motion of the head of the user.

FIG. 9 is a flow chart showing steps of a method for hands free operating of a head mounted device, according to an example embodiment.

FIG. 10 is a flow chart showing steps of a method for hands free operating of a head mounted device, according to another example embodiment.

FIG. 11 illustrates a diagrammatic representation of an example machine in the form of a computer system within which a set of instructions for causing the machine to perform any one or more of the methodologies discussed herein is executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The techniques of the embodiments disclosed herein may be implemented using a variety of technologies. For example, the methods described herein may be implemented in software executing on a computer system or in hardware utilizing either a combination of microprocessors or other specially designed application-specific integrated circuits (ASICs), programmable logic devices, or various combinations thereof. In particular, the methods described herein may be implemented by a series of computer-executable instructions residing on a storage medium such as a disk drive, or computer-readable medium. It should be noted that methods disclosed herein can be implemented by a computer (e.g., a desktop computer, tablet computer, laptop computer, and a car computer), game console, handheld gaming device, cellular phone, smart phone, photo and video camera, a smart TV set, and so forth.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments.

Embodiments of present disclosure allow a user to operate a head mounted device in a hands free manner. Some example operations include image and video viewing on a screen of the head mounted device, navigation of menus and applications, receiving blueprints, checklists, text messages, instructions, and so forth. The image viewing and navigation can be controlled by specific head movements of a user.

Embodiments of the present technology can be practiced in various sterile environments including: engineering/manufacturing clean rooms, surgery operating rooms, pharmaceutical manufacturing, and so forth.

Embodiments disclosed herein can allow visualization of data and team collaboration, for example, in medical applications including improvement of surgical teams' situational awareness and operational efficiency and reducing ST-segment Elevation Myocardial Infarction (STEMI) Door-to-Balloon Time. In assembly or manufacturing situations, blueprints and engineering images and instructions can be viewed in detail by the technician without the contamination of bringing additional resources into the clean room environment.

Embodiments of the present technology can be practiced with variety of devices including but not limited to augmented reality glasses and virtual reality devices.

According to an example embodiment, the method for hands free operating of a head mounted device includes reading sensor data from at least one sensor associated with a head mounted device. The head mounted device can be worn by a user. The method can allow recognizing, based on the sensor data, a gesture generated by a movement of the head of the user. In response to the recognition, the method can perform an operation of the head mounted device. The operation can be associated with the recognized gesture and a mode of the head mounted device.

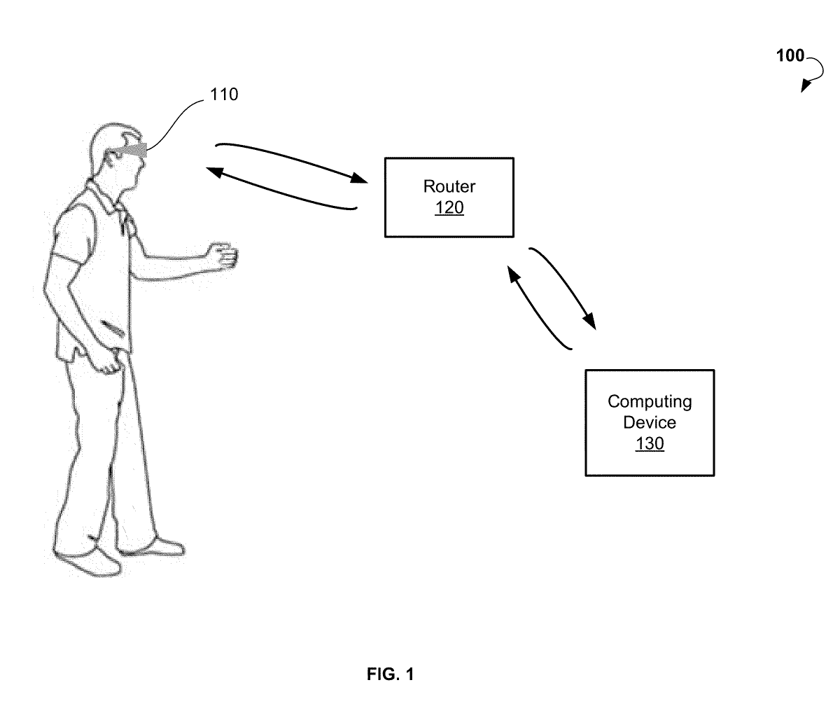

FIG. 1 is a block diagram showing an example environment 100, within which methods for hands free operating of a head mounted device can be practiced. The environment 100 can include a head mounted device 110, a router 120, and a computing device 130.

The head mounted device 110 can be configured to be worn by a user on the head and include a graphic display system (also referred to as a screen) or an optical projection system operable to at least provide images or a set of images to the user. In various embodiments, the head mounted display 110 can include a head mounted display, smart glasses, augmented reality glasses, virtual reality devices, and the like.

In various embodiments, the head mounted device 110 is communicatively coupled to the computing device 130 via the router 120. The head mounted device 110 can be operable to communicate with the computing device 130 via a wireless networks using Wi-Fi, Bluetooth, and other protocols. In some embodiments, the computing device 130 is operable to store at least images and information related to the images. The images can be provided to the head mounted device 110 upon a request. In various embodiments, the computing device 130 includes a smart phone, a mobile phone, a tablet computer, a notebook, a desktop computer, and so forth.

In certain embodiments, the head mounted device 110 and/or computing device 130 are communicatively coupled via the Internet, a cellular phone network, a satellite network, and the like to one or more cloud-based computing resource(s) (also referred to as a computing cloud). In some embodiments, the computing cloud is operable to store at least images and information related to the images and to provide the images to computing device 130 and further to head mounted device 110.

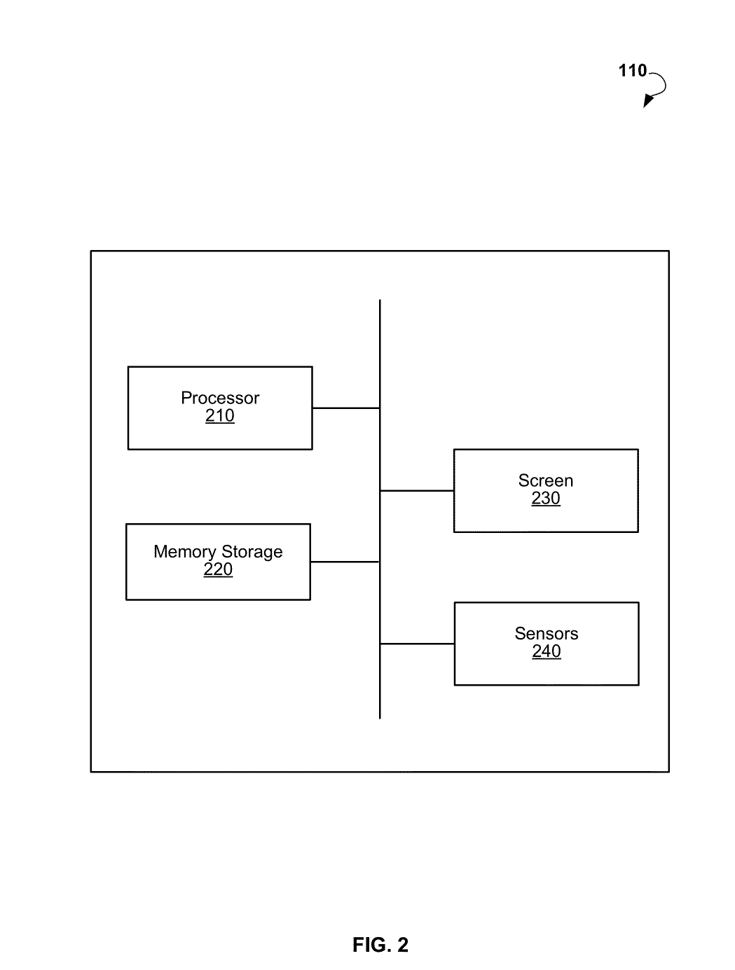

FIG. 2 is a block diagram showing components of an example head mounted device 110. The example head mounted device 110 includes a processor 210, a memory storage 220, a graphic display system (a screen) 230, and sensors 240. In some embodiments, the head mounted device 110 includes components which are additional to or different from the components mentioned above. Such components may be necessary, advantageous, or helpful to operations of the head mounted device. For example, the graphic display system 230 can be replaced with an optical projection system. The optical projection system can provide the user with an augmented reality screen by projecting images through one or more micro projectors without losing the site of the real physical view. The optical projection system can be turned on and off during operation of the head mounted device.

In some embodiments, processor 210 includes hardware and software implemented as a processing unit, which is operable to process floating point operations and other operations for the head mounted device 110. In some embodiments, processor 210 executes instructions stored in the memory storage 220 to perform functionality described herein, including the method for hands free operating of a head mounted device.

In various embodiments, the sensors 240 can include one or more of the following: an accelerometer, a gyroscope, an inertial measurement unit, and the like. An accelerometer can operable to measure acceleration along one or more axes, for example the axes which are mutually perpendicular to each other. A gyroscope can be operable to measure rotational movement. Data received from sensors 240 can be analyzed by the processor 210 to recognize one or more specific movements (gestures) of the head of the user.

In various embodiments, the graphic display system (a screen) 230 can be configured to provide a graphic user interface. In some embodiments, the graphic display system 230 can be configured to display an image or a set of images. In certain embodiments, the graphic display system 230 can be operable to perform manipulations with an image or a set of images in response to recognized gestures of the head of the user.

In various embodiments, the gestures that the user generates by moving the head can be used to control other operations, for example, hands free interactions with images and videos on a screen of head mounted device 110, hands free activation of features on head mounted device 110 including initiating and accepting/denying incoming calls, text messages, and video calls.

Further embodiments can include the following features activated through the head gesture control: audio and text conversion, streaming point-of-view video to remote consultants, sharing camera snapshots with hands free head gesture zooming and panning capabilities, sharing annotations of snapshots, viewing real-time patient vital signs, viewing x-rays and Magnetic resonance imaging (MRI) with a hands free zoom, viewing real-time endoscopy and fluoroscopy video, viewing blueprints, schematics, instruction manuals and checklists.

In some embodiments, the head mounted device 110 may recognize following head gestures and perform an operation assigned to the gesture:

1) Rotating the head to the right to cause a right arrow or D-pad right press.

2) Rotating the head to the left to cause a left arrow or D-pad left press.

3) Tilting the head down (pitch down) to perform a selection action or D-pad center press.

4) Tilting head up (pitch up) to perform a ‘back’ action or D-pad up press.

5) Tilting head right (roll) to enable or disable an active hands free navigation. In some embodiments, when the head mounted display is disabled and operates in a ‘Standby mode’, a head tilt to the right, followed by a configured hold time, is used to bring the head mounted display into an active hands free navigation mode. Holding the head in a right tilt reduces unintentional activation of the hands free system. Additionally, left and right tilts (rolls) of the head can be configured for other operations, for example, to regulate a volume of a sound.

In some embodiments, the head mounted device 110 is operable to operate in at least three modes that help a user to manipulate controls for viewing the image(s) in various ways. The example, the modes can include “zoom”, “pan”, and “scroll”. In some embodiments, the current mode is shown by graphic display system 230, for example, at left low corner of a screen.

In further embodiments, the head mounted device 110 is operable to navigate through menus and/or applications and to make selections using the head gestures.

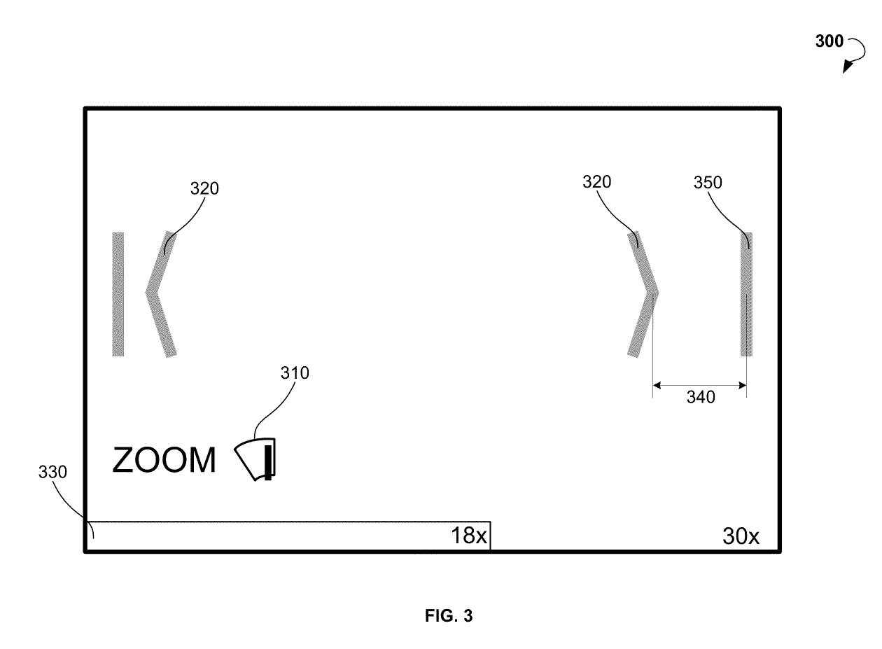

FIG. 3 illustrates an example screen 300 of a “zoom” mode for hands free viewing images on a head mounted device. The screen 300 includes a dial indicator 310 for switching modes, arrows 320, and a (progressing) bar 330. The “zoom” mode can allow the user magnifying the image from 100% (a full image is shown on screen) up to a pre-defined maximum magnification. As the user rotates the head right from the center, the image is magnified. When the user rotates the head left from the center, the image is reduced. The speed at which the image is magnified or reduced is in a ratio to the angle the user's head is rotated from the center. The farther the rotation from center, the quicker the magnification changes.

Arrows 320 on the right and on the left show visual feedback for how far from the center the user's head is rotated. The feedback can be provided by changing a distance 340 between the arrow 320 and a vertical side line 350. At the bottom of the screen the progression bar 330 shows the current level of magnification. The progression bar 330 changes (in length) as the user increases or decreases the magnification level. The bar can also show the current and maximum magnification levels.

In some embodiments, thresholds for left and right rotations are pre-determined to allow magnification to only start once a minimum degree of rotation have been reached. The threshold allows a small room for error so that the user is not changing magnification with a small (and possibly unintentional) left or right head rotation.

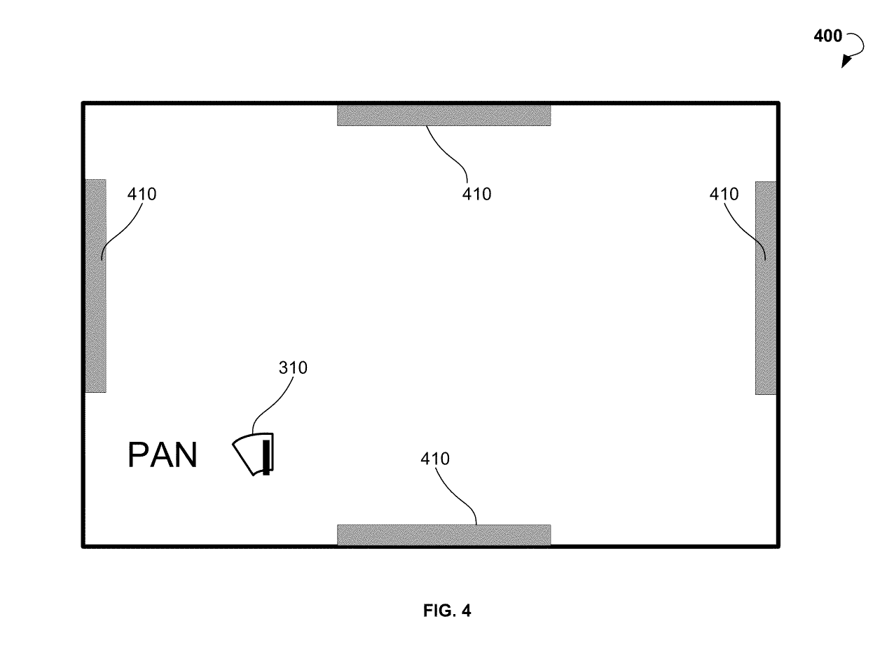

FIG. 4 illustrates an example screen 400 of a “pan” mode for hands free viewing images on a head mounted device. The screen 400 can includes a dial indicator 310 for switching modes and scrollbars 410. The “pan” mode allows the user to pan around the image to allow full viewing even when the image is greatly magnified. The panning is controlled by the pitch and rotation of the user's head. When the image is magnified, only a small portion is visible on the screen. As the user “looks around” (changes the pitch and rotation), the user “sees” the image section that would correspond to what the user would see if the image was physically in front of the user and a few feet away. Thus, as the user looks up and to the right, the user is able to see the upper-right part of the image.

The scrollbars 410 located on the sides of the screen can allow the user to see both the magnification level and the placement of the viewport inside the full image. The scrollbars move in ratio to the viewport of the image while panning. When the user is viewing the center of the image, the scrollbars are centered both vertically and horizontally. When the user pans to the right edge of the image, the top and bottom scrollbars also move right in ratio with the image until the scrollbar is also at the right edge of the screen. The same is true for panning left in the image. When the user pans up and down the left and right scrollbars move in ratio with the panning action until the scrollbars reach the top or bottom of the screen. The size of the scrollbars is in ratio to the size of the magnification of the image. Thus, if the image is at 2× magnification, the scrollbars are 50% the size of the screen. If the image is at 4× magnification the scrollbars are 25% of the screen and so on.

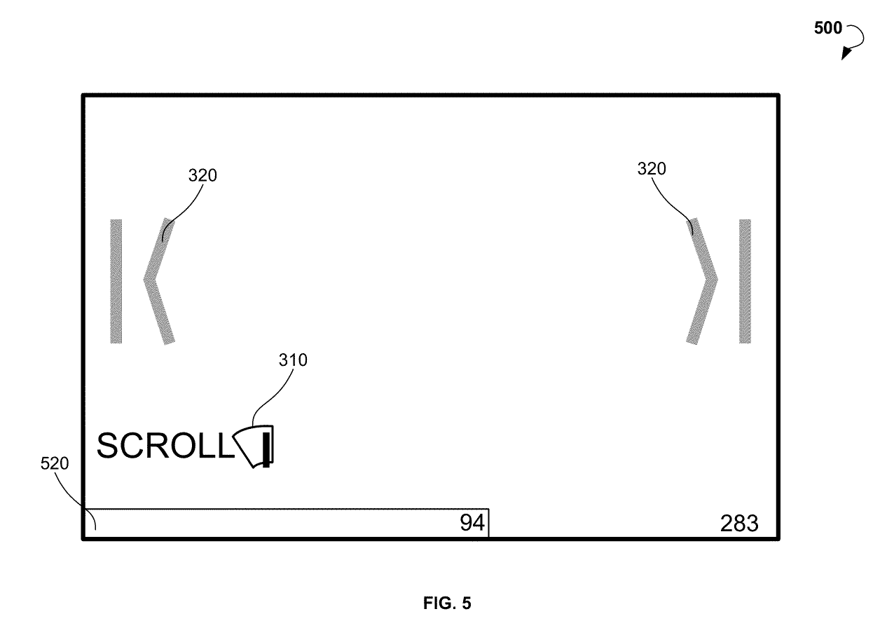

FIG. 5 illustrates an example screen 500 of a “scroll” mode for hands free viewing images on a head mounted device. The screen 400 can include a dial indicator 310 for switching modes, arrows 320, and a bar 510. The “scroll” mode can allow the user navigating (scrolling) through series of the images in a hands free manner. The images can be related to each other and combined into a series, for example in medical imagery, video frames, a picture gallery, blueprint pages and other fields.

Image series scrolling can be controlled by left and right head rotations. As the user rotates the head to the right, the image series can progress forward in a ratio to the angle of the rotation from the center. The farther the user rotates his/her head right, the faster the images set scrolls forward. As the user rotates the head to the left, the images are scrolled backwards in a ratio to the angle of the rotation.

Arrows 320 on the right and left of the screen 500 show visual feedback for how far from the center the user rotate his/her head.

In some embodiments, thresholds are also pre-defined to allow scrolling to commence, move forward or backward once a minimum degree of the rotation has been reached. This allows a room for error so there is no scrolling when there is very little rotation of the head from the center.

In some embodiments, the bar at the bottom of the screen is configured to show the current image/frame and total images in the series.

In some embodiments, the scrolling can be performed vertically using a rotation of the head up and down. The speed of the scrolling can be proportional to a ratio of the angle of rotation to a maximum pre-determined value.

In certain embodiments, the scrolling can be used for navigating a long menu, a list of icons of applications, and other lists of items.

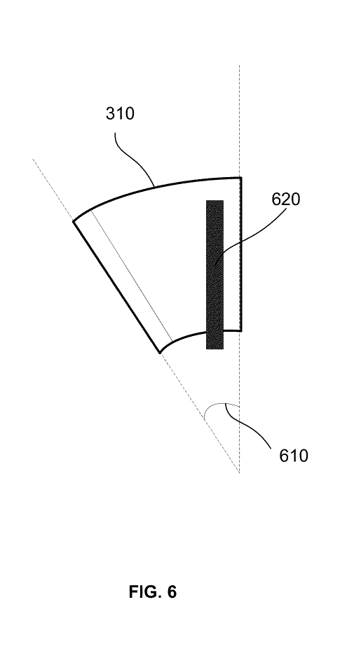

FIG. 6 illustrates a dial indicator 310 for switching modes of a head mounted device, according to an example embodiment. In some embodiments, the user can switch between modes with a left head tilt to a pre-determined angle 610 or beyond. In certain embodiments, the pre-determined angle 610 is set to approximately 15 degrees to the left of the vertical line 620. The dial indicator shows constant visual feedback of how much the user is currently tilting their head by rotating the dial indicator from the pivot point at 620. The target area of the dial indicator shows where an action will be triggered when that threshold is reached.

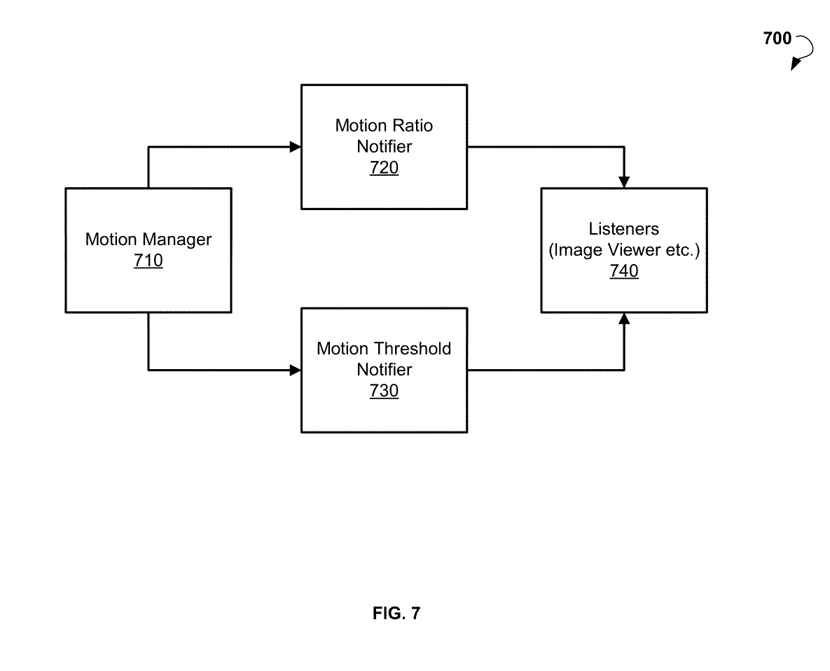

FIG. 7 is a block diagram showing a system 700 for hands free operating of a head mounted device, according to an example embodiment. The system can include a motion manager 710, a motion ratio notifier 720, a motion threshold notifier 730, and listeners 740. The listeners include at least an image viewer. The above modules 710-740 can be implemented as instructions stored in memory storage 220 and executed by processor 210. The system 700 can be connected to a sensor manager of the head mounted device 110.

In some embodiments, the motion manager 710 is operable to receive raw sensor data from a sensor manager and convert the received data to pitch, tilt, rotation, yaw, and roll.

In some embodiments, the motion ratio notifier 720 is initialized with minimum and maximum values for a specific motion, such as pitch, yaw, or roll. The motion ration notifier 720 can be further configured to monitor data received from the motion manager 710 and to convert the received data to ratios valued from 0.0 to 1.0. The ratio values can be provided to listeners 740, for example to the image viewer. The image viewer can be operable to place, based on the ratios, graphic elements into corresponding positions relative to the motion of the sensors.

In some embodiments, the motion threshold notifier 730 is initialized with minimum and/or maximum threshold values for a specific axis. The motion threshold notifier 730 can be configured to receive an input from the motion manager 710. The motion threshold notifier 730 can be further configured to notify listeners 740 when the predefined thresholds are exceeded.

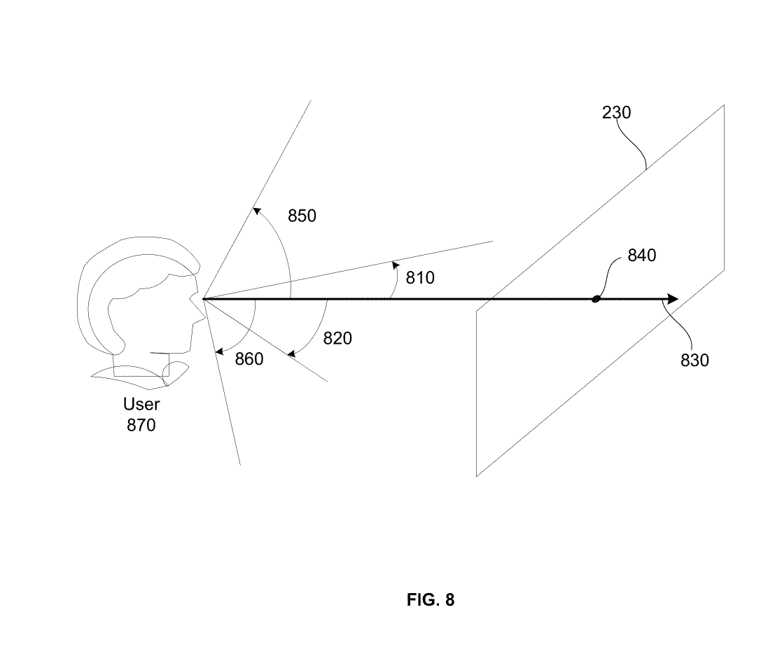

FIG. 8 is a block diagram showing example parameters associated with the motion of the head of the user. In some embodiments, the parameters are determined by the motion manager 710 based on the sensor data collected by gyroscopes, accelerators and other sensors installed on the head mounted device. In some embodiments, the parameters include angles 810 and 820 in the horizontal surface relative to the screen 230. The angles 810 and 820 can be determined relative to a central axis 830 passing through the central point 840 of the screen 230 when the user 870 turns his/her head to the left or to the right of the central point 840. In some embodiments, the angle 810 and 820 can be used to determine a horizontal ratio relative to a pre-determined maximum left or right angles for the horizontal rotation of the head. The horizontal ratio can be provided to listeners 740, for example, the image viewer. Based on the horizontal ratio, the image viewer can zoom in or zoom out an image (depending on the direction of rotation of the head) with a speed proportional to the horizontal ratio while the head mounted device operates in the “zoom” mode. Similarly, when the head mounted device operates in the “scroll” mode, the horizontal ratio can be used to determine a speed for scrolling the set of images backward and forward depending on the direction of the rotation of the head.

Similarly, in some embodiments, the determined parameters include angles 850 and 860 in a vertical surface relative to the screen 230. The angles 850 and 860 can be determined relative to the central axis 830 passing through the central point 840 on the screen 230 when the user 870 turns his/her head up and down from the central point 840. In some embodiments, the angles 850 and 860 are used to determine a vertical ratio relative to pre-determined up or down maximum angles for a vertical rotation of the head. The vertical ratio can be provided to the image viewer. The image viewer can use the vertical ratio and the horizontal ratio to determine a speed for panning an image in direction of the movement of the head. The image can be displayed on the screen 230 while the head mounted device operates in the “pan” mode.

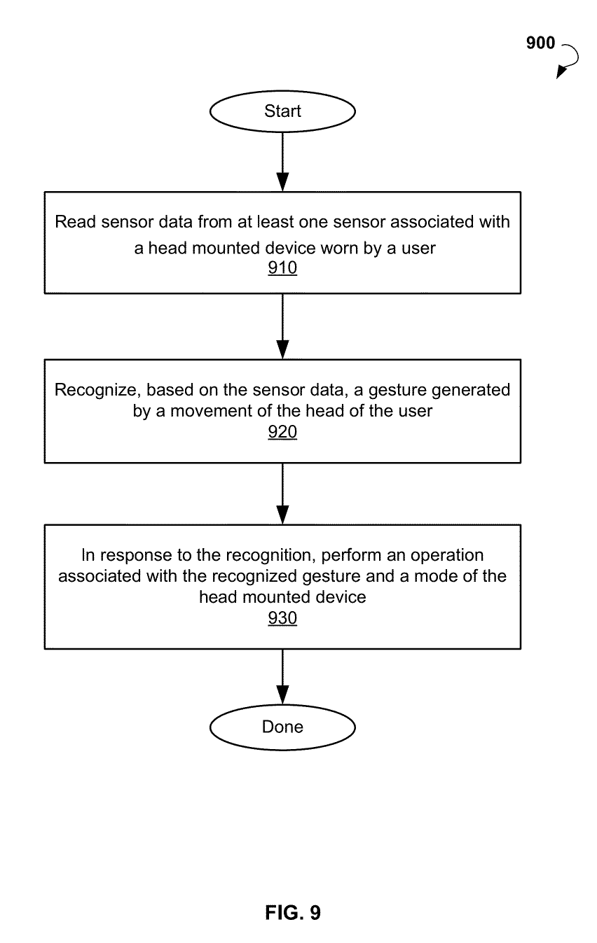

FIG. 9 illustrates a flow chart diagram showing a method 900 for hands free operating of a head mounted device, according to an example embodiment. The method 900 can commence at block 910 with reading sensor data from at least one sensor associated with a head mounted device worn by a user. At block 920, a gesture can be recognized based on the sensor data. The gesture can be generated by a movement of the head of the user. At block 930, in response to the recognition, an operation of the head mounted device is performed. The operation can be associated with the recognized gesture and a mode of the head mounted device.

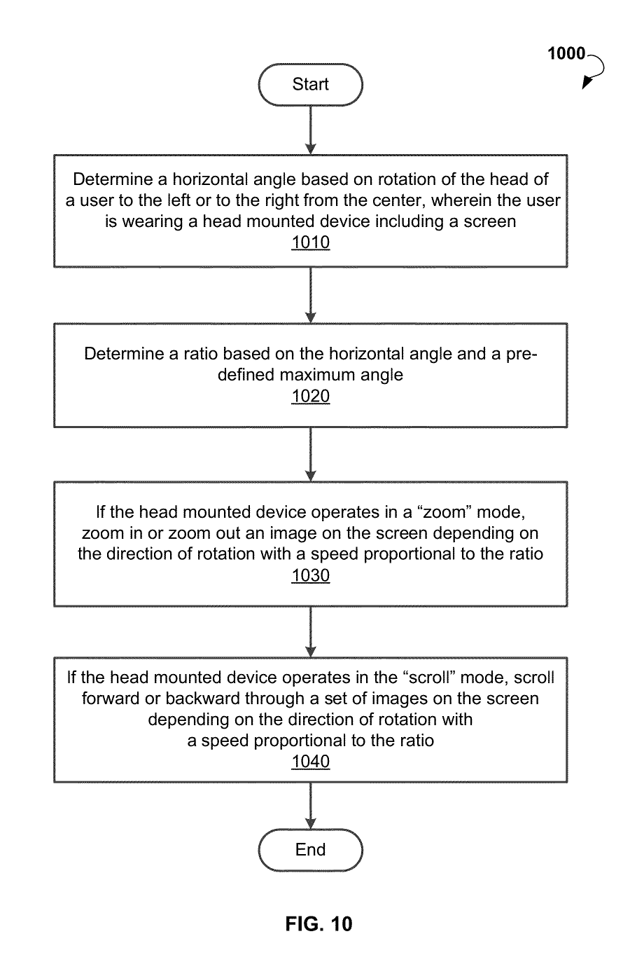

FIG. 10 is a flow chart diagram showing a method 1000 for hands free operating of a head mounted device, according to another example embodiment. The method 1000 can commence at block 1010 with determining a horizontal angle based on rotation of the head of a user to the left or to the right of the center. The user can wear a head mounted device. The head mounted device can include a screen.

At block 1020, the method 1000 can proceed with determining a ratio based on the horizontal angle and a pre-defined maximum angle.

At block 1030, the method 1000 can include zooming in or zooming out an image on the screen depending on the direction of the rotation with a speed proportional to the ratio if the head mounted device operates in the “zoom” mode.

At block 1040, the method 1000 can include scrolling forward or backward through a set of images on the screen depending on the direction of rotation with a speed proportional to the ratio if the head mounted device is operating in the “scroll” mode.

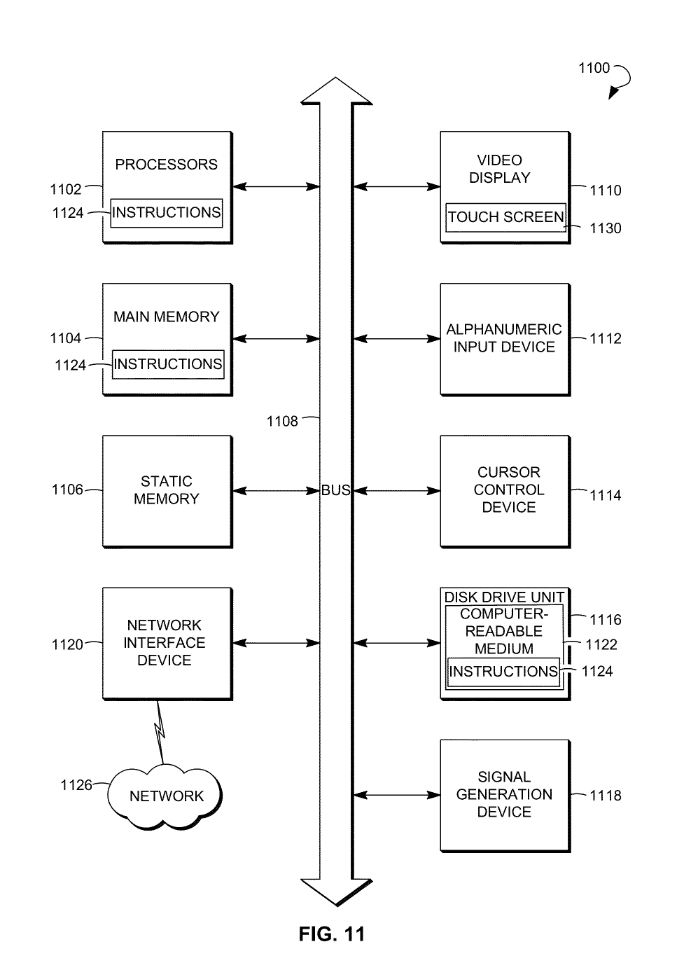

FIG. 11 illustrates a diagrammatic representation of an example machine in the form of a computer system within which a set of instructions for causing the machine to perform any one or more of the methodologies discussed herein is executed. A computer system 1100 may include a set of instructions for causing the machine to perform any one or more of the methodologies discussed herein. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a tablet computer, a car computer with a touchscreen user interface, a cellular telephone, a smartphone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor or multiple processors 1102 (e.g., a central processing unit (CPU), a graphics processing unit (GPU), or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 may also include an alphanumeric input device 1112 (e.g., a keyboard), a cursor control device 1114 (e.g., a mouse), a disk drive unit 1116, a signal generation device 1118 (e.g., a speaker), and a network interface device 1120. The computer system 1100 may further include a touch input device, such as a touch screen 1130, touch pad, a multi touch surface, and so forth. The computer system 1100 may also include a gesture recognizing device, for example, a wired glove, a depth camera, an infrared (IR) camera, stereo camera, and the like.

The disk drive unit 1116 includes a computer-readable medium 1122, on which is stored one or more sets of instructions and data structures (e.g., instructions 1124) embodying or utilized by any one or more of the methodologies or functions described herein. The instructions 1124 may also reside, completely or at least partially, within the main memory 1104 and/or within the processors 1102 during execution thereof by the computer system 1100. The main memory 1104 and the processors 1102 may also constitute machine-readable media.

The instructions 1124 may further be transmitted or received over a network 1126 via the network interface device 1120 utilizing any one of a number of well-known transfer protocols (e.g., Hyper Text Transfer Protocol (HTTP)).

While the computer-readable medium 1122 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks (DVDs), random access memory (RAM), read only memory (ROM), and the like.

The example embodiments described herein may be implemented in an operating environment comprising software installed on a computer, in hardware, or in a combination of software and hardware.

Thus, systems and methods for hands free operating of a head mounted device have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A method for hands free operating of a head mounted device, the method comprising:
reading sensor data from at least one sensor associated with a head mounted device, the head mounted device being worn by a user;
recognizing, based on the sensor data, a gesture generated by a movement of a head of the user; and
in response to recognition, performing an operation of the head mounted device, the operation being associated with the recognized gesture and a mode of the head mounted device.

2. The method of claim 1, wherein the gesture includes one or more of the following: a rotation, a pitch, and a roll.

3. The method of claim 1, wherein the operation includes one of: zooming in and zooming out an image displayed by a screen of the head mounted device, panning the image on the screen, scrolling a series of images on the screen, and switching the mode.

4. The method of claim 3, wherein the switching the mode is carried out in response to a left head tilt to at least a pre-determined angle.

5. The method of claim 3, wherein:
the zooming out the image is carried out in response to rotating the head from a center to the right; and
the zooming in the image is carried out in response to rotating the head from the center to the left.

6. The method of claim 3, wherein a direction of scrolling the series of the images is determined in response to rotating the head from a center to the left or to the right.

7. The method of claim 1, wherein recognizing of gestures includes determining a ratio based at least on an angle associated with the movement and a pre-determined maximum angle in a direction of the movement.

8. The method of claim 7, wherein a speed of execution of the operation is proportional to the ratio.

9. The method of claim 8, further comprising providing at least one indicator on a screen associated with the head mounted device, the at least one indicator showing a degree of fulfillment of the operation.

10. The method of claim 1, wherein recognizing the gesture includes
determining that parameters of the movement exceed minimal pre-defined thresholds.

11. A system for hands free operating of a head mounted device, the system comprising:
a processor;
a memory communicatively coupled to the processor, the memory storing instructions which when executed by the processor perform operations comprising:
reading sensor data from at least one sensor associated with a head mounted device, the head mounted device being worn by a user;
recognizing, based on the sensor data, a gesture generated by a movement of a head of the user; and
in response to the recognition, performing an operation of the head mounted device, the operation being associated with the recognized gesture and a mode of the head mounted device.

12. The system of claim 11, wherein the gesture includes one or more of the following: a rotation, a pitch, and a roll.

13. The system of claim 11, wherein the operation includes one of the following: zooming in and zooming out an image displayed by a screen of the head mounted device, panning the image on the screen, scrolling a series of images on the screen, and switching the mode.

14. The system of claim 13, wherein the switching of the mode is carried out in response to a left head tilt to at least a pre-determined angle.

15. The system of claim 13, wherein:
the zooming out of the image is carried out in response to rotating the head from a center to the right; and
the zooming in the image is carried out in response to rotating the head from the center to the left.

16. The system of claim 13, wherein a direction of scrolling the series of the images is determined in response to rotating the head from the center to the left or to the right.

17. The system of claim 11, wherein recognizing the gestures includes determining a ratio based at least on an angle associated with the movement and a pre-determined maximum angle in a direction of the movement.

18. The system of claim 17, wherein a speed of execution of the operation is proportional to the ratio.

19. The method of claim 18, further comprising providing at least one indicator on a screen associated with the head mounted device, the at least one indicator showing a degree of fulfillment of the operation.

20. A non-transitory computer-readable medium having instructions stored thereon, which when executed by one or more processors, perform the following operations:
reading sensor data from at least one sensor associated with a head mounted device, the head mounted device being worn by a user;
recognizing, based on the sensor data, a gesture generated by a movement of a head of the user; and
in response to recognition, performing an operation of the head mounted device, the operation being associated with the recognized gesture and a mode of the head mounted device.
